(19) United States
(12) Patent Application Publication
(10) Pub. No.: US 2025/0323827 A1
(43) Pub. Date: Oct. 16, 2025

(54) ETHERNET PROTOCOL-BASED MONITORING SYSTEM

(71) Applicant: GENESIS TECHNOLOGY (USA) INC., Phoenix, AZ (US)

(72) Inventors: Sheng-Yuan LIN, Hsinchu City (TW); Hsiang-Hao HU, Hsinchu City (TW)

(73) Assignee: GENESIS TECHNOLOGY (USA) INC., Phoenix, AZ (US)

(21) Appl. No.: 19/075,189

(22) Filed: Mar. 10, 2025

(30) Foreign Application Priority Data
Apr. 10, 2024 (TW) 113203490

(51) Int. Cl. H04L 41/069; H04L 41/0213; H04L 41/0681; H04L 43/0817

(52) U.S. Cl. CPC H04L 41/069; H04L 41/0213; H04L 41/0681; H04L 43/0817

(57) ABSTRACT

An Ethernet protocol-based monitoring system monitors multiple devices in a loop network and includes a first status collection server, a second status collection server, a processor, and an output module. The first status collection server which generates at least one first warning notification includes a first collection module and a second collection module, which respectively obtain the device statuses of the devices in an active manner and a passive manner. The second status collection server receives the Syslog data of the plurality of devices based on a Syslog service, thereby generating at least one second warning notification. The processor sets a warning condition and compares the first warning notification, the second warning notification, and the warning condition to determine whether a warning event occurs. The output module provides the warning event for a user to view. The present invention integrates different communication protocols to achieve more complete monitoring.

### BACKGROUND OF THE INVENTION

This application claims priority for the TW patent application Ser. No. 11/320,3490 filed on 10 Apr. 2024, the content of which is incorporated by reference in its entirely.

### FIELD OF THE INVENTION

The present invention relates to a network-monitoring field, particularly to an Ethernet protocol-based monitoring system.

### DESCRIPTION OF THE RELATED ART

Device monitoring is achieved by sending back the status information of devices to the backend server. Maintenance engineers determine whether the device has any abnormality based on preset conditions, keywords, or values. Sometimes the conditions are set relatively loosely. Under the loose conditions, the device has actually experienced an abnormality but has not yet required to be shut down. Thus, no warning notification will be issued. However, in some cases, even a slight abnormality may cause the device to shut down. For example, the device with both parts will not shut down until both parts are damaged. Therefore, if only one part is damaged, the system will not issue a warning after determination. However, when the device encounters a more serious situation in the future, the abnormal event of the previously damaged part is likely to be ignored.

In addition, most current monitoring systems collect device status data based on a single communication protocol. However, each communication protocol has different ways of collecting data and determining whether to issue a warning. It is possible that the abnormalities of devices that need to issue warnings will be missed due to differences in preset debugging conditions. If the accuracy of monitoring can be increased and the shutdown of devices can be avoided, the losses caused by the shutdown can be avoided.

Accordingly, the present invention provides an Ethernet protocol-based monitoring system to address conventional deficiencies and future needs. The specific architecture and implementations thereof are detailed as follows:

### SUMMARY OF THE INVENTION

The primary objective of the present invention is to provide an Ethernet protocol-based monitoring system, which uses different communication protocols to compensate for each other's shortcomings and monitor the statuses of devices in a loop network. This can avoid being ignored by the monitoring system when the minor abnormal status of the device occurs. For example, when the device is offline, the passive monitoring manner will not be able to know the status of the device, resulting in the dilemma of downtime for maintenance.

Another objective of the present invention is to provide an Ethernet protocol-based monitoring system that performs monitoring using a simple network management protocol (SNMP) poller and a SNMP_Trap message combined with system logging protocol (Syslog) data.

According to the foregoing objective, the present invention provides an Ethernet protocol-based monitoring system configured to monitor a plurality of devices in a loop network. The Ethernet protocol-based monitoring system includes:
a first status collection server, including a first collection module and a second collection module, configured to generate at least one first warning notification, wherein the first collection module and the second collection module are respectively configured to obtain device statuses of the plurality of devices in an active manner and a passive manner;
a second status collection server configured to receive system logging protocol (Syslog) data of the plurality of devices based on a system logging protocol (Syslog), thereby generating at least one second warning notification;
a processor, connected to the first status collection server and the second status collection server, setting a warning condition, wherein the processor is configured to compare the at least one first warning notification, the at least one second warning notification, and the warning condition to determine whether a warning event occurs; and
an output module connected to the processor and configured to provide the warning event for a user to view.

According to an embodiment of the present invention, the first status collection server is configured to collect data and warn based on a simple network management protocol (SNMP).

According to an embodiment of the present invention, the first collection module sets a debugging condition. The first collection module is configured to discover and poll the plurality of devices based on a simple network management protocol (SNMP). When there is an event that meets the debugging condition in the device statuses, the first collection module actively collects the event and generates the first warning notification.

According to an embodiment of the present invention, the first collection module further includes a poller group to expand the number of the plurality of devices that have the collectable device statuses.

According to an embodiment of the present invention, the second collection module sets a debugging condition. The plurality of devices automatically send a SNMP_Trap message to the second collection module based on a simple network management protocol (SNMP) trap service. The second collection module is configured to analyze the SNMP_Trap message based on the debugging condition, thereby generating a SNMP_Trap warning notification.

According to an embodiment of the present invention, the first status collection server further includes a first database that is connected to the first collection module and the second collection module and configured to store the device statuses collected by the first collection module and the second collection module and the at least one first warning notification. The first database is a distributed storage-based database cluster.

According to an embodiment of the present invention, the second status collection server includes an engine cluster for searching and analyzing data that is configured to analyze the Syslog data.

According to an embodiment of the present invention, the second status collection server includes a second database that is configured to store the Syslog data of the plurality of devices. The second database is a distributed storage-based database cluster.

According to an embodiment of the present invention, the output module is configured to display the first warning notification, the second warning notification, and the device statuses of the plurality of devices that are viewed by the user. The device statuses include the real-time statuses and historical statuses of the plurality of devices.

According to an embodiment of the present invention, the processor further includes a third database that is a Microsoft SQL database.

According to an embodiment of the present invention, the output module further includes a fourth database that is a MySQL database.

Below, the embodiments are described in detail in cooperation with the drawings to make easily understood the technical contents, characteristics and accomplishments of the present invention.

### BRIEF DESCRIPTION OF THE DRAWINGS

FIG. 1 is a block diagram illustrating an Ethernet protocol-based monitoring system according to an embodiment of the present invention;

FIG. 2 is a detailed block diagram illustrating an Ethernet protocol-based monitoring system according to an embodiment of the present invention;

FIG. 3 and FIG. 4 are schematic diagrams illustrating an Ethernet protocol-based monitoring system according to an embodiment of the present invention; and

FIG. 5 is a schematic diagram illustrating an Ethernet protocol-based monitoring system according to another embodiment of the present invention.

### DETAILED DESCRIPTION OF THE INVENTION

The technical solutions in the embodiments of the present invention will be clearly and completely described below with reference to the drawings in the embodiments of the present invention. Obviously, the described embodiments are part of the embodiments of the present invention, not all of the embodiments. Based on the embodiments of the present invention, all other embodiments obtained by those skilled in the art without making inventive efforts should be included within the scope of the present invention.

It should be understood that, when used in this specification and the scope of the claims, the terms “comprising” and “including” refer to the presence of a stated feature, whole, step, operation, element, and/or component, but does not exclude the presence or addition of one or more other features, wholes, steps, operations, elements, components and/or combinations of these.

It should also be understood that the terms used in the specification of the present invention are only used to describe particular embodiments but not intended to limit the present invention. As used in this specification and the claims, the singular forms “a,” “an,” and “the” are intended to include the plural forms unless the context clearly dictates otherwise.

It should further be understood that the terms “and/or” used in the specification and the claims refer to any and all possible combinations of one or more of the associated listed items and include these combinations.

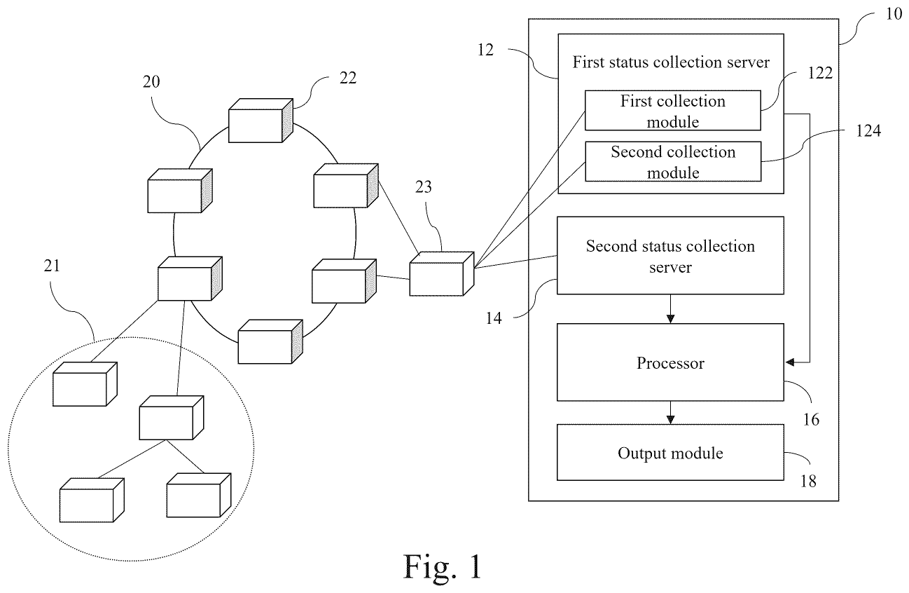

The present invention provides an Ethernet protocol-based monitoring system. Please refer to FIG. 1. FIG. 1 is a block diagram illustrating an Ethernet protocol-based monitoring system 10 according to an embodiment of the present invention. The Ethernet protocol-based monitoring system 10 of the present invention is configured to monitor a plurality of devices 22 in a loop network 20. The loop network 20 uses the resilient Ethernet protocol (REP). The devices are specific switches or specific routers. Only specific switches or specific routers can form the loop network 20. Other network devices 21 are connected to the network through the loop network 20 formed by the devices 22. These network devices 21 can be any type of network devices such as wireless network connectors, switches, routers, etc., and a connection is established among the other network devices 21 based on the spanning tree protocol (STP). The resilient Ethernet protocol has the advantages of fast repair time and network flexibility among different devices, making it very suitable for use in the industrial automation industry. After multiple devices 22 are connected to form a loop topology based on the flexible Ethernet protocol, they are connected to the Ethernet protocol-based monitoring system 10 of the present invention through a connection port device 23. A connection is established between the connection port device 23 and the device 22 in the loop network 20 based on the spanning tree protocol (STP). The Ethernet protocol-based monitoring system 10 of the present invention includes a first status collection server 12, a second status collection server 14, a processor 16, and an output module 18. The first state collection server 12 includes a first collection module 122 and a second collection module 124. The first collection module 122, the second collection module 124, and the second state collection server 14 are connected to the connection port device 23. The first state collection server 12 and the second state collection server 14 are also connected to the processor 16. The processor 16 is connected to the output module 18.

The first status collection server 12 collects data and warns based on a simple network management protocol (SNMP). The first collection module 122 obtains the device statuses of the devices 22 and the other network devices 21 in an active manner. The second collection module 124 obtains the device statuses of the devices 22 and the other network devices 21 in a passive manner.

In an embodiment, the first collection module 122 a SNMP poller. The first collection module 122 sets a debugging condition. The first collection module 122 discovers and polls the devices 22 and the other network devices 21 based on a simple network management protocol (SNMP). When there is an event that meets the debugging condition in the device status of the device 22 or the network device 21, the first collection module 122 actively collects the event from the device status transmitted by the loop network 20 and generates a first warning notification. In an embodiment, the second collection module 124 sets a debugging condition based on a SNMP trap service. When the device 22 or the network device 21 sends a SNMP_Trap message in response to the SNMP trap, the SNMP_Trap message is transmitted to the second collection module 124 through the connection port module 23. The second collection module 124 uses a management information base to analyze the SNMP Trap message and compares the SNMP_Trap message with the debugging condition to generate a SNMP_Trap warning notification. It should be noted that the debugging conditions set by the first collection module 122 and the second collection module 124 may be identical or different. The first collection module 122 actively collects an abnormal event from the device statuses. The second collection module 124 passively receives the SNMP_Trap message from the device.

The second status collection server 14 receives the system logging protocol (Syslog) data of the devices 22 the network devices 21 based on a system logging protocol (Syslog). Regardless of whether the second status collection server 14 has set a debugging condition or a debugging value, the second status collection server 14 can receive the complete Syslog data of the devices 22 and the network devices 21. Assume that the second status collection server 14 has set the debugging condition or the debugging value. When the Syslog data of any device 22 or the other network device 21 meet the debugging condition or the debugging value, the second status collection server 14 will find the Syslog data that meet the debugging condition or the debugging value and generate at least one second warning notification.

The processor 16 integrates the data generated by the first status collection server 12 and the second status collection server 14, including the device status obtained by the first status collection server 12, the first warning notification generated by the first collection module 122, the SNMP_Trap message received by the second collection module 124, the SNMP Trap warning notification generated by the second collection module 124, and the Syslog data obtained by the second status collection server 14, and the second warning notification generated by the second status collection server 14. The processor 16 sets a warning condition, which is a keyword or a combination of a keyword and a number, and compares the first warning notification and the second warning notification with the warning condition. If the warning condition meets the first warning notification and the second warning notification, a warning event that requires maintenance has indeed occurred in the device 22 or the network device 21. The processor 16 will immediately notify the user or maintenance personnel of the event. If the warning condition only meets one of the first warning notification or the second warning notification, the processor 16 will still immediately notify the user or maintenance personnel of the event. The present invention uses both SNMP and Syslog communication protocols in order to make the data complementary. Because the Syslog and SNMP_Trap are passive methods for waiting for the device 22 or the network device 21 to send out messages. As a result, the present invention performs SNMP polling to actively and regularly determine whether the device 22 or the network device 21 has an abnormal status, so as to avoid the second collection module 124 and the second status collection server 14 from missing any abnormal status. For example, when the device is offline, the passively monitoring method will not be able to know the device status.

The output module 18 is configured to provide the warning event for a user or maintenance personnel to view. In addition to the warning event, the output module 18 further displays the first warning notification, the second warning notification, and the device status of the device 22 or the network device 21 and provides them for the user to view. The device status includes the real-time status and the historical status of the device.

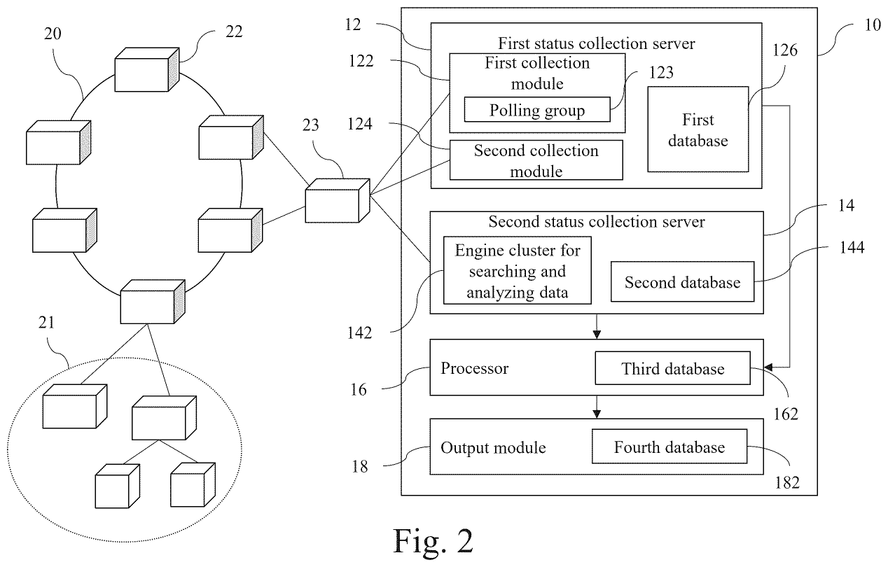

Refer to FIG. 2. FIG. 2 is a detailed block diagram illustrating an Ethernet protocol-based monitoring system according to an embodiment of the present invention. The first collection module 122 further includes a polling group 123, which provides traverse performance expansion, thereby being able to handle a larger number of devices 22 and other network devices 21. The first status collection server 12 further includes a first database 126 connected to the first collection module 122 and the second collection module 124. The first database 126 is a distributed storage-based database cluster (e.g., MySQL Cluster). The first database 126 is used to store the device statuses collected by the first collection module 122 and the second collection module 124, the first warning notification, and the SNMP_Trap warning notification. The second status collection server 14 includes an engine cluster for searching and analyzing data (e.g., an Elasticsearch Cluster) 142 and a second database 144. The engine cluster 142 for searching and analyzing data is used to analyze the Syslog data and compare the Syslog data with the debugging condition (e.g., determine whether the Syslog data contains the word “error”). If the result is yes, a second warning notification is issued. The second database 144 is a distributed storage-based database cluster (e.g., a MongoDB Cluster), which is used to store the Syslog data of the device 22 and other network devices 21. Since the engine cluster 142 for searching and analyzing data and the database cluster are clusters composed of multiple hosts, they also provide the functions of traverse performance expansion to handle a large number of devices 22 and other network devices 21. The processor 16 further includes a third database 162, which is a Microsoft SQL database. The output module 18 further includes a fourth database 182, which is a MySQL database. The third database 162 and the fourth database 182 are both used to store the data and warnings received by the third database 162 and the fourth database 182. The third database 162 also stores the warning event that meets the warning condition.

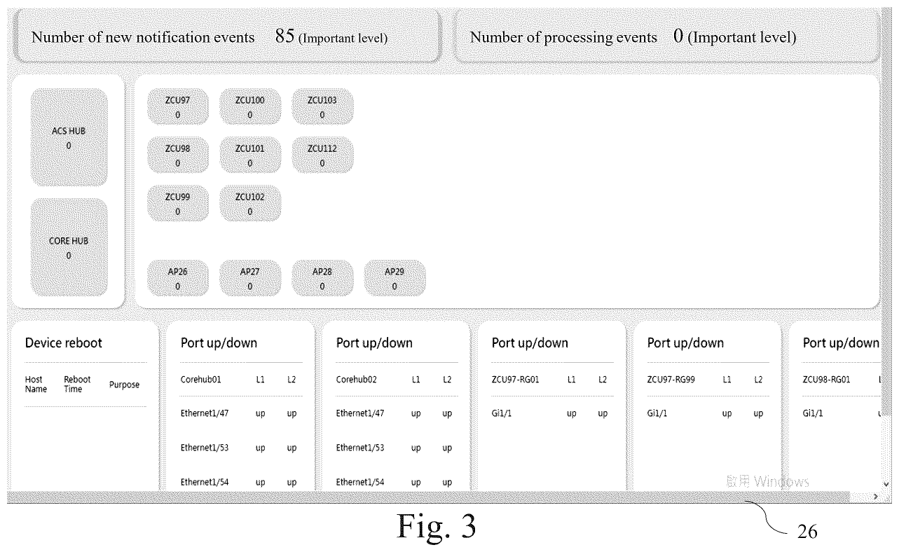

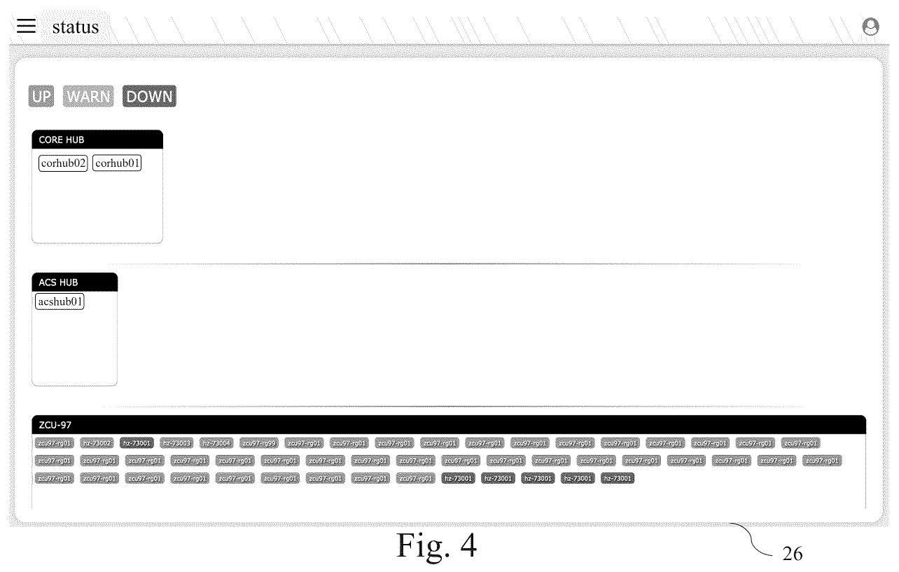

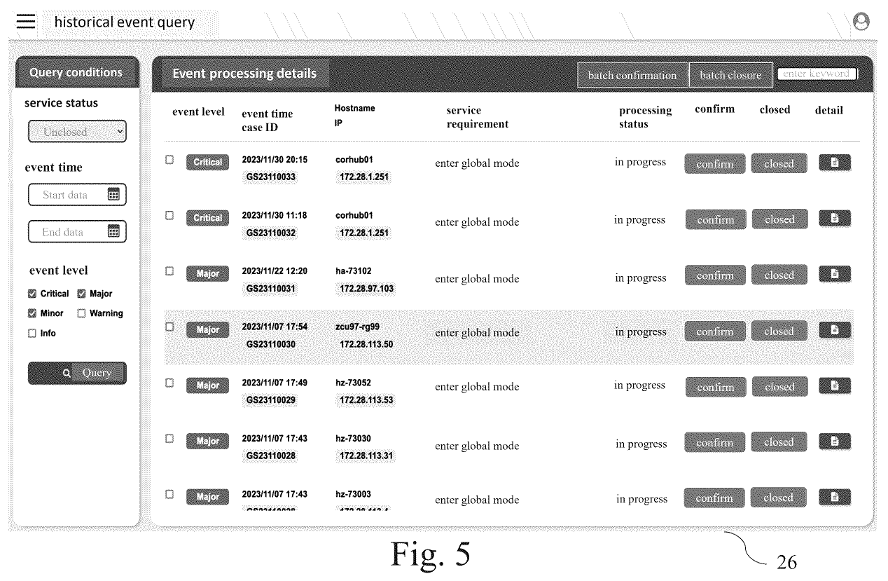

The user utilizes the Ethernet protocol-based monitoring system 10 to perform monitoring, wherein the monitoring display screen is illustrated in FIGS. 3 to 5. The monitoring screen 26 in FIG. 3 displays the number of warning events that have occurred and lists the device numbers of the warning events that have occurred. Each of ACS Hub and Core Hub is the connection port device 23 in FIG. 1, and the number displayed below is the number of offline devices. ZCU97, ZCU98, and AP26 all represent one of the loops (group names) composed of the devices 22, and the number below is the number of offline devices in the loop. The monitoring screen 26 of FIG. 4 shows two core hubs and one Cisco security control server (e.g., an ACS hub), and all three devices are operating normally. The device statuses (including UP, Warning, or Down) of 85 devices 22 are listed in the lower part of the monitoring screen 26 of FIG. 4. Then, as illustrated in FIG. 5, it is a historical event query. After setting the query conditions in the left field of the monitoring screen 26, the event processing details are listed in the right field, including the event level, event occurrence time, device IP location, processing status, case status, etc., so that users or maintenance personnel can see it at a glance.

In conclusion, the Ethernet protocol-based monitoring system uses different communication protocols such as the SNMP poller, the SNMP Trap, and the Syslog to compensate for each other's shortcomings and monitor the statuses of devices in the loop network. This can avoid being ignored by the monitoring system to result in the dilemma of downtime for maintenance when the minor abnormal status of the device occurs.

The embodiments described above are only to exemplify the present invention but not to limit the scope of the present invention. Therefore, any equivalent modification or variation according to the shapes, structures, features, or spirit disclosed by the present invention is to be also included within the scope of the present invention.

What is claimed is:

1. An Ethernet protocol-based monitoring system, configured to monitor a plurality of devices in a loop network, the Ethernet protocol-based monitoring system comprising:
a first status collection server, including a first collection module and a second collection module, configured to generate at least one first warning notification, wherein the first collection module and the second collection module are respectively configured to obtain device statuses of the plurality of devices in an active manner and a passive manner;
a second status collection server configured to receive system logging protocol (Syslog) data of the plurality of devices based on a system logging protocol (Syslog), thereby generating at least one second warning notification;
a processor, connected to the first status collection server and the second status collection server, setting a warning condition, wherein the processor is configured to compare the at least one first warning notification, the at least one second warning notification, and the warning condition to determine whether a warning event occurs; and
an output module connected to the processor and configured to provide the warning event for a user to view.

2. The Ethernet protocol-based monitoring system according to claim 1, wherein the first status collection server is configured to collect data and warn based on a simple network management protocol (SNMP).

3. The Ethernet protocol-based monitoring system according to claim 2, wherein the first collection module sets a debugging condition, the first collection module is configured to discover and poll the plurality of devices based on the simple network management protocol, and when there is an event that meets the debugging condition in the device statuses, the first collection module actively collects the event and generates the at least one first warning notification.

4. The Ethernet protocol-based monitoring system according to claim 2, the first collection module further includes a poller group to expand number of the plurality of devices that have the collectable device statuses.

5. The Ethernet protocol-based monitoring system according to claim 1, wherein the second collection module sets a debugging condition, the plurality of devices automatically send a SNMP_Trap message to the second collection module based on a simple network management protocol (SNMP) trap service, and the second collection module is configured to analyze the SNMP Trap message based on the debugging condition, thereby generating a SNMP_Trap warning notification.

6. The Ethernet protocol-based monitoring system according to claim 1, wherein the first status collection server further includes a first database that is connected to the first collection module and the second collection module and configured to store the device statuses collected by the first collection module and the second collection module and the at least one first warning notification, and the first database is a distributed storage-based database cluster.

7. The Ethernet protocol-based monitoring system according to claim 1, wherein the second status collection server includes an engine cluster for searching and analyzing data that is configured to analyze the Syslog data.

8. The Ethernet protocol-based monitoring system according to claim 1, wherein the second status collection server includes a second database that is configured to store the Syslog data of the plurality of devices, and the second database is a distributed storage-based database cluster.

9. The Ethernet protocol-based monitoring system according to claim 1, wherein the output module is configured to display the at least one first warning notification, the at least one second warning notification, and the device statuses of the plurality of devices that are viewed by the user, and the device statuses include real-time statuses and historical statuses of the plurality of devices.

10. The Ethernet protocol-based monitoring system according to claim 1, wherein the processor further includes a third database that is a Microsoft SQL database.

11. The Ethernet protocol-based monitoring system according to claim 1, wherein the output module further includes a fourth database that is a MySQL database.
